(19) United States
(12) Patent Application Publication
(10) Pub. No.: US 2023/0213935 A1
(43) Pub. Date: Jul. 6, 2023

(54) METHODS AND SYSTEMS FOR PROVIDING DRONE-ASSISTED MEDIA CAPTURE

(71) Applicant: Toyota Motor Engineering & Manufacturing North America, Inc., Plano, TX (US)

(72) Inventors: Rohit Gupta, Santa Clara, CA (US); Akila C. Ganlath, San Jose, CA (US); Prashant Tiwari, Santa Clara, CA (US)

(73) Assignee: Toyota Motor Engineering & Manufacturing North America, Inc., Plano, TX (US)

(21) Appl. No.: 17/568,249

(22) Filed: Jan. 4, 2022

(51) Int. Cl. G05D 1/00; G05D 1/02; B64C 39/02

(52) U.S. Cl. CPC G05D 1/0033; G05D 1/0251; G05D 1/0276; B64C 39/024; B64C 2201/127; B64C 2201/146

(57) ABSTRACT

A method may include receiving a request for drone-assisted media capture from a vehicle located at a first location, the request specifying one or more user preferences, selecting an unmanned aerial vehicle that is able to perform the drone-assisted media capture based on the user preferences, causing the selected unmanned aerial vehicle to travel to the first location, and causing the selected unmanned aerial vehicle to capture media at the first location based on the user preferences.

### TECHNICAL FIELD

The present specification relates to drone service and more particularly to methods and systems for providing drone-assisted media capture.

### BACKGROUND

When a driver drives a vehicle, the vehicle may pass by scenery, roadside attractions, wildlife, or other images that the driver may wish to capture in a photograph or other media. However, taking photographs while driving may be dangerous. However, drones are able to take photographs by flying to a location and capturing one or more images using a camera.

### SUMMARY

In an embodiment, a method may include receiving a request for drone-assisted media capture from a vehicle located at a first location, the request specifying one or more user preferences, selecting an unmanned aerial vehicle that is able to perform the drone-assisted media capture based on the user preferences, causing the selected unmanned aerial vehicle to travel to the first location, and causing the selected unmanned aerial vehicle to capture media at the first location based on the user preferences.

In another embodiment, a remote computing device may include a processor configured to receive a request for drone-assisted media capture from a vehicle located at a first location, the request specifying one or more user preferences, select an unmanned aerial vehicle that is able to perform the drone-assisted media capture based on the user preferences, cause the selected unmanned aerial vehicle to travel to the first location, and cause the selected unmanned aerial vehicle to capture media at the first location based on the user preferences.

In another embodiment, a system may include a plurality of unmanned aerial vehicles and a remote computing device. The remote computing device may store drone registration information indicating performance capabilities of each of the unmanned aerial vehicles. The remote computing device may include a processor configured to receive a request for drone-assisted media capture from a vehicle located at a first location, the request specifying one or more user preferences, select an unmanned aerial vehicle that is able to perform the drone-assisted media capture based on the user preferences, cause the selected unmanned aerial vehicle to travel to the first location, and cause the selected unmanned aerial vehicle to capture media at the first location based on the user preferences.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1A schematically depicts a system for providing drone-assisted media capture, according to one or more embodiments shown and described herein;

FIG. 1B schematically depicts another view of the system of FIG. 1A, according to one or more embodiments shown and described herein;

FIG. 2 depicts a schematic diagram of a vehicle system, according to one or more embodiments shown and described herein;

FIG. 3 depicts a schematic diagram of the memory modules of the vehicle system of FIG. 2, according to one or more embodiments shown and described herein;

FIG. 4 depicts a schematic diagram of a remote computing device, according to one or more embodiments shown and described herein;

FIG. 5 depicts a flowchart of a method of operating the vehicle system of FIGS. 2 and 3 to provide drone-assisted media capture, according to one or more embodiments shown and described herein; and

FIG. 6 depicts a flowchart of a method of operating the remote computing device of FIGS. 1A, 1B and 4 to provide drone-assisted media capture, according to one or more embodiments shown and described herein.

### DETAILED DESCRIPTION

Vehicle drivers may often pass by interesting scenery or images that they may desire to capture in a photograph or other media. However, taking a photograph while driving may be difficult and/or dangerous as it may distract the driver from driving. In addition, taking a photograph from a driving vehicle may result in a low quality photograph. Accordingly, disclosed herein are methods and systems for providing drone-assisted media capture.

In embodiments disclosed herein, while a user is driving a vehicle, if the user sees a scene that they wish to take a photograph or video or capture audio of, the user may order drone-assisted media capture service. In particular, the user may order a drone to fly to the location where the vehicle is located and have the drone capture a photograph or video of the scene at the location. The captured photograph may then be transmitted to the user for the user to view at a later time when they are no longer driving the vehicle. As such, the drone service may allow the user to conveniently capture an image of a scene viewed by the user while driving the vehicle.

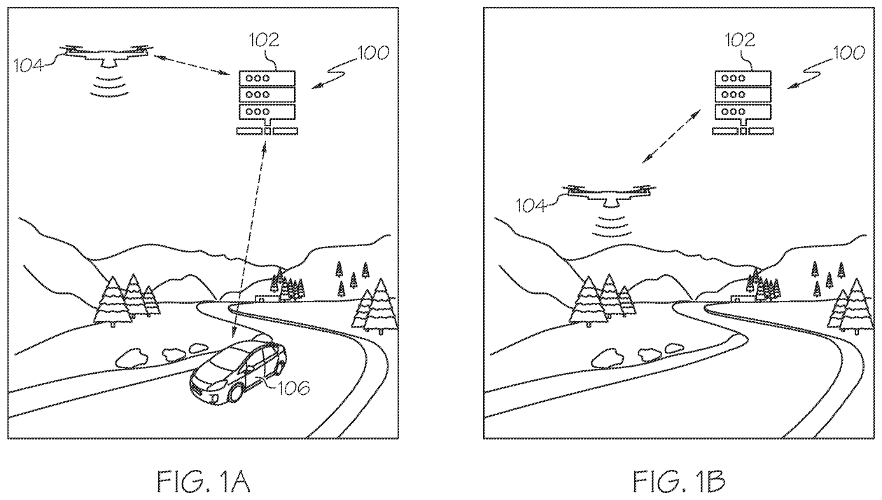

Turning now to the figures, FIGS. 1A and 1B schematically depict a system for providing drone-assisted media capture. As shown in FIGS. 1A and 1B, a system 100 includes a drone management server 102 and one or more unmanned aerial vehicles (UAVs) 104. As disclosed herein, unmanned aerial vehicles may be referred to as drones. As used herein, media may refer to photographs, video, and/or audio.

In the illustrated example, a drone 104 may be capable of flying to a location and capturing media. In some examples, the drone 104 may take photographs using an on-board camera. In some examples, the drone 104 may capture video using an on-board camera. In some examples, the drone may capture audio using an on-board microphone. The drone 104 may be communicatively coupled to the drone management server 102. The drone 104 may receive control commands from the drone management server 102 and may transmit captured media to the drone management server 102, as disclosed herein. In embodiments, the drone 104 may be controlled autonomously, remotely by a drone operator, or by the drone management server 102.

The drone management server 102 may be communicatively coupled to the drone 104 and to a vehicle 106, as shown in FIG. 1A. The drone management server 102 may receive requests for drone-assisted media capture from the vehicle 106 and may transmit commands to the drone 104, as disclosed herein. In some examples, the drone management server 102 may control operation of the drone 104. In other examples, the drone management server 102 may transmit commands to cause the drone 104 to perform drone-assisted media capture either autonomously or under the control of a drone operator.

The drone management server 102 may be a remote computing device. In the illustrated example, the drone management server 102 comprises a cloud computing device. In some examples, the drone management server 102 may comprise a road-side unit (RSU) positioned near a road. In these examples, the system 100 may include any number of RSUs spaced along one or more roads such that each RSU covers a different service area. That is, as the vehicle 106 or other vehicles drive along one or more roads, the vehicles may be in range of different RSUs at different times such that different RSUs provide coverage at different locations. Thus, as the vehicle 106 drives along one or more roads, the vehicle 106 may move between coverage areas of different RSUs.

In other examples, the drone management server 102 may be another type of server or remote computing device and may be positioned remotely from any particular road. In some examples, the drone management server 102 may be an edge server. In some examples, the drone management server 102 may be a moving edge server, such as another vehicle.

When a driver of the vehicle 106 would like to capture images, video, or audio of a scene, the driver may request drone-assisted media capture, as disclosed herein. The request for drone-assisted media capture may request that a drone fly to the location of the vehicle 106 and capture one or more photographs, video, and/or audio of the location where the vehicle 106 is located at the time of the request. The request for drone-assisted media capture may be transferred to the drone management server 102.

Upon receiving a request for drone-assisted media capture, the drone management server 102 may identify a drone that is able to perform the requested service (e.g., the drone 104). The drone 104 may then fly to the location that the vehicle was located when the request was made, as shown in FIG. 1B. The drone 104 may capture one or more photographs, video, and/or audio desired by the driver of the vehicle 106. The request may specify whether a user desires photographs, video, audio, or any combination thereof. The drone 104 may transmit the captured media to the drone management server 102, which may then transmit the captured media to the driver of the vehicle 106 (e.g., via e-mail or a web portal). The driver may then view and/or listen to the captured media when they are no longer driving the vehicle 106 (e.g., after arriving home). In some examples, the drone 104 may transmit the captured media to the vehicle 106 as it is captured in real-time. Additional details of the system 100 are discussed further below.

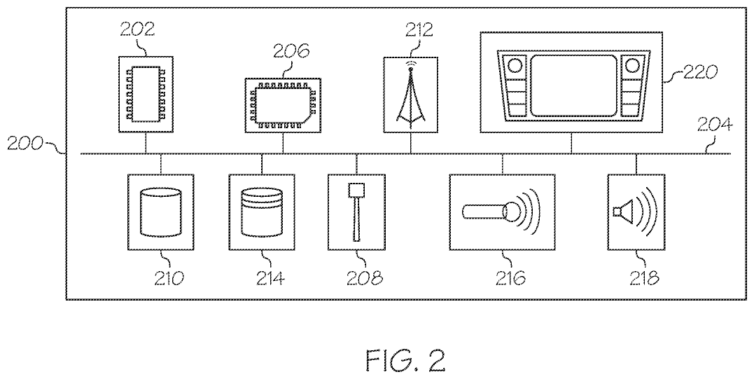

FIG. 2 depicts a vehicle system 200 that may be included in the vehicle 106 of FIG. 1. In the example of FIG. 2, the vehicle system 200 includes one or more processors 202, a communication path 204, one or more memory modules 206, a satellite antenna 208, one or more vehicle sensors 210, a network interface hardware 212, a data storage component 214, an audio input device 216, an audio output device 218, and a display device 220, the details of which will be set forth in the following paragraphs.

Each of the one or more processors 202 may be any device capable of executing machine readable and executable instructions. Accordingly, each of the one or more processors 202 may be a controller, an integrated circuit, a microchip, a computer, or any other computing device. The one or more processors 202 are coupled to a communication path 204 that provides signal interconnectivity between various modules of the system. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as Wi-Fi, Bluetooth®, Near Field Communication (NFC) and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

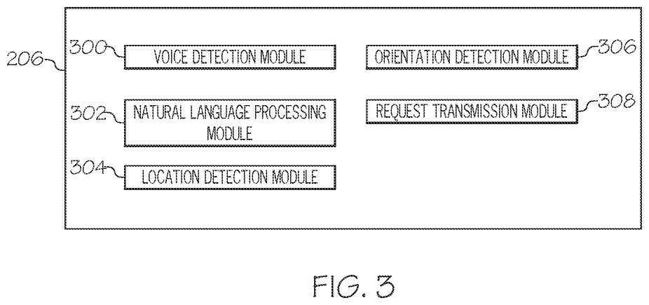

The vehicle system 200 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The memory modules 206 are discussed in further detail with respect to FIG. 3.

Referring still to FIG. 2, the vehicle system 200 comprises a satellite antenna 208 coupled to the communication path 204 such that the communication path 204 communicatively couples the satellite antenna 208 to other modules of the vehicle system 200. The satellite antenna 208 is configured to receive signals from global positioning system satellites. Specifically, in one embodiment, the satellite antenna 208 includes one or more conductive elements that interact with electromagnetic signals transmitted by global positioning system satellites. The received signal is transformed into a data signal indicative of the location (e.g., latitude and longitude) of the satellite antenna 208, and consequently, the vehicle containing the vehicle system 200.

The vehicle system 200 comprises one or more vehicle sensors 210. Each of the one or more vehicle sensors 210 is coupled to the communication path 204 and communicatively coupled to the one or more processors 202. The one or more vehicle sensors 210 may include, but are not limited to, LiDAR sensors, RADAR sensors, optical sensors (e.g., cameras, laser sensors), proximity sensors, location sensors (e.g., GPS modules), and the like. In embodiments, the vehicle sensors 210 may determine an orientation of the vehicle 106 (e.g., a direction that the vehicle 106 is heading). In other examples, the vehicle sensors 210 may detect other information about the vehicle 106 and/or its surroundings.

Still referring to FIG. 2, the vehicle system 200 comprises network interface hardware 212 for communicatively coupling the vehicle system 200 to the drone management server 102. The network interface hardware 212 can be communicatively coupled to the communication path 204 and can be any device capable of transmitting and/or receiving data via a network. Accordingly, the network interface hardware 212 can include a communication transceiver for sending and/or receiving any wired or wireless communication. For example, the network interface hardware 212 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 212 includes hardware configured to operate in accordance with the Bluetooth® wireless communication protocol. In embodiments, the network interface hardware 212 of the vehicle system 200 may transmit a request for drone-assisted media capture to the drone management server 102, as disclosed herein.

Still referring to FIG. 2, the vehicle system 200 comprises a data storage component 214. The data storage component 214 may store data used by various components of the vehicle system 200.

The vehicle system 200 further comprises an audio input device 216 and an audio output device 218. The audio input device 216 may be an in-vehicle microphone which may detect voice commands of vehicle occupants, as disclosed in further detail below. The audio output device 218 may be an in-vehicle speaker that may output audio received by the drone 104 and/or the drone management server 102. In some examples, the vehicle system 200 may receive audio signals (e.g., a confirmation of a request for drone-assisted media capture or a request for more information) from the drone 104 and/or the drone management server 102. In these examples, the audio output device 218 may output the received audio such that a driver of the vehicle 106 can verbally communicate with the drone 104 and/or the drone management server 102.

The vehicle system 200 further comprises a display device 220 (e.g., a digital screen). In some examples, the drone 104 and/or the drone management server 102 may transmit captured images to the vehicle system 200, which may be displayed on the display device 220. In some examples, the drone 104 may transmit an image of the drone's field of view to the vehicle system 200, which may be displayed on the display device 220. As such, a driver of the vehicle 106 may view the captured images while driving the vehicle 106. In some embodiments, the display device 220 may be a head-up display, or any augmented reality or virtual reality device.

In some embodiments, the vehicle system 200 may be communicatively coupled to the drone management server 102 by a network. In one embodiment, the network may include one or more computer networks (e.g., a personal area network, a local area network, or a wide area network), cellular networks, satellite networks and/or a global positioning system and combinations thereof. Accordingly, the vehicle system 200 can be communicatively coupled to the network via a wide area network, via a local area network, via a personal area network, via a cellular network, via a satellite network, etc. Suitable local area networks may include wired Ethernet and/or wireless technologies such as, for example, Wi-Fi. Suitable personal area networks may include wireless technologies such as, for example, IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

Now referring to FIG. 3, the one or more memory modules 206 of the vehicle system 200 include a voice detection module 300, a natural language processing module 302, a location detection module 304, an orientation detection module 306, and a request transmission module 308.

The voice detection module 300 may detect a voice of a driver or other occupant of the vehicle 106 via the audio input device 216. In particular, the voice detection module 300 may detect vocal commands of a vehicle occupant requesting drone-assisted media capture, as disclosed herein.

As discussed above, as the vehicle 106 drives along a road, the driver or other vehicle occupant may desire to take a photograph or capture other media of a scene they are driving passed. However, it may be difficult and/or dangerous for the driver to take a photograph while driving the vehicle. As such, the driver may request drone-assisted media capture, as disclosed herein. In the illustrated embodiment, the driver may request drone-assisted media capture using voice commands, thereby allowing the driver to make the request with minimal distraction to the driving of the vehicle 106.

When the driver uses a voice command to request drone-assisted media capture, the voice command may be detected by the voice detection module 300. In some examples, the voice detection module 300 may be in constant listening mode to detect a voice command comprising a request for drone-assisted media capture. For example, the voice detection module 300 may detect certain words associated with a request for drone-assisted media capture (e.g., “take photograph”). In some examples, the voice detection module 300 may only listen for a voice command comprising a request for drone-assisted media capture after hearing a wake word. In other examples, the voice detection module 300 may only listen for a voice command comprising a request for drone-assisted media capture after the driver turns on a drone-assisted media capture system in the vehicle (e.g., by pressing a button on a vehicle console). In embodiments, after the voice detection module 300 detects a voice command associated with a request for drone-assisted media capture, the detected voice command may be stored in the data storage component 214 and the voice command may be analyzed by the natural language processing module 302, as described below.

The natural language processing module 302 may analyze a voice command requesting drone-assisted media capture detected by the voice detection module 300 as disclosed herein. In embodiments, the natural language processing module 302 may perform natural language processing of a voice command to determine the content of the voice command and formulate a request that may be transmitted to the drone management server 102.

The natural language processing module 302 may utilize a variety of natural language processing algorithms to analyze the voice command detected by the voice detection module 300. In particular, the natural language processing module 302 may determine the content of the voice command indicating details of the request for drone-assisted media capture. A request for drone-assisted media capture may include a variety of user preferences or specifications. A simple request may simply be a request to take a photograph (e.g., “take a photograph here”). However, a request for drone-assisted media capture may also include more user preferences specifying the request. In some examples, user preferences may specify whether photographs, video, audio, or any combination thereof is desired to be captured.

For example, a request could specify a direction or orientation that a photograph should be taken with respect to the vehicle 106 (e.g., “take a photo to the left of the car”). A request could specify a specific feature to capture (e.g., “take a picture of the ocean”). A request could specify a position from which a photograph should be taken (e.g., “take a picture from above the trees in front of me”). A request could specify a time that a photograph should be taken (e.g., “take a picture just before sunset”). Other non-limiting examples of user preferences or specifications that can be included in a request for drone-assisted media capture are a height that a photograph should be taken from, a perspective or angle that a photograph should be taken from, a time of day or date that a photograph should be taken, a season of the year when a photograph should be taken from, an external lighting condition when a photograph should be taken, and the like. In some examples, a request for drone-assisted media capture may identify parameters of a camera to be used (e.g., a minimum pixel rate). In some examples, a request may include a request for video in addition to or instead of photographs.

The natural language processing module 302 may parse the contents of a voice command received by the voice detection module 300 to determine user preferences or parameters associated with media that the driver of the vehicle 106 has requested to be taken (e.g., time, location, orientation, and the like). In some examples, the natural language processing module 302 may access external information to determine parameters of a request based on the voice command. For example, if the driver of the vehicle 106 states “take a picture of the lake”, the natural language processing module 302 may access a digital map of the location where the vehicle 106 is located to identify a lake that the driver is likely referring to.

In some examples, the natural language processing module 302 may utilize a lookup table to look up words detected by the voice detection module 300 and associate them with a request for drone-assisted media capture. For example, the natural language processing module 302 may look up different words associated with photograph or associated with orientations. After processing the voice command detected by the voice detection module 300, the natural language processing module 302 may formulate a request for drone-assisted media capture including parameters based on the detected voice command.

In some examples, the vehicle system 200 may utilize a method other than voice commands to receive a request for drone-assisted media capture from a driver. For example, a driver may utilize a touch screen or other input method to request drone-assisted media capture. In these examples, the voice detection module 300 and the natural language processing module 302 may be omitted from the memory modules 206 of the vehicle system 200.

The location detection module 304 may detect the location of the vehicle 106 when the voice command is detected by the voice detection module 300. In particular, the location detection module 304 may determine the vehicle's location based on signals received by the satellite antenna 208. The vehicle location may be transmitted to the drone management server 102 along with the request for drone-assisted media capture, as disclosed herein.

The orientation detection module 306 may detect the orientation of the vehicle 106 when the voice command is detected by the voice detection module 300. In particular, the orientation detection module 306 may determine the direction that the vehicle 106 is facing based on the vehicle sensors 210. The vehicle orientation may be transmitted to the drone management server 102 along with the request for drone-assisted media capture, as disclosed herein.

The request transmission module 308 may transmit the request for drone-assisted media capture formulated by the natural language processing module 302 based on the voice command detected by the voice detection module 300, along with the vehicle location determined by the location detection module 304 and the vehicle orientation determined by the orientation detection module 306 to the drone management server 102. The drone management server 102 may provide drone-assisted media capture service based on the received request and vehicle location and orientation information, as described in further detail below.

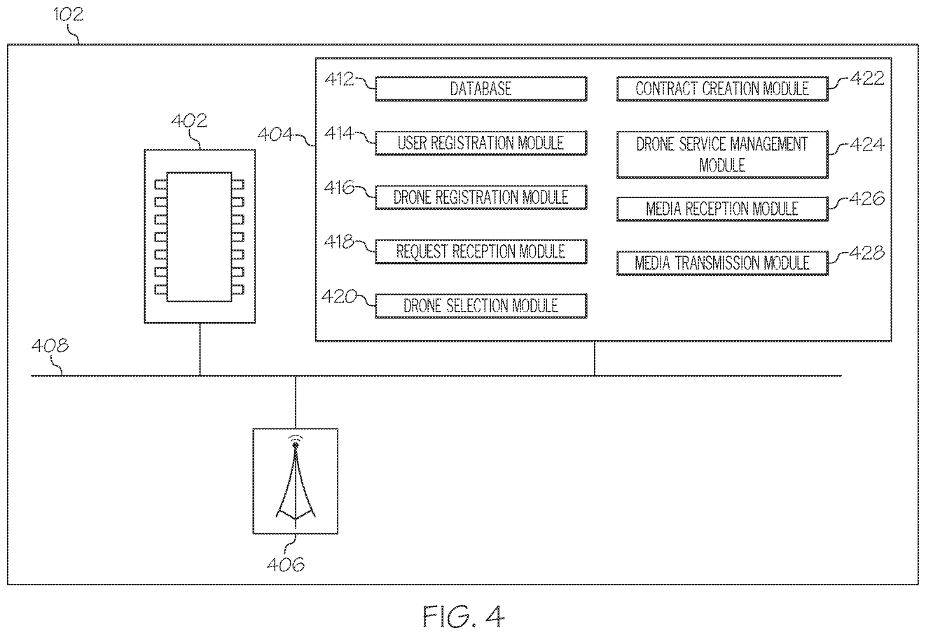

Now referring to FIG. 4, the drone management server 102 comprises one or more processors 402, one or more memory modules 404, network interface hardware 406, and a communication path 408. The one or more processors 402 may be a controller, an integrated circuit, a microchip, a computer, or any other computing device. The one or more memory modules 404 may comprise RAM, ROM, flash memories, hard drives, or any device capable of storing machine readable and executable instructions such that the machine readable and executable instructions can be accessed by the one or more processors 402.

The network interface hardware 406 can be communicatively coupled to the communication path 408 and can be any device capable of transmitting and/or receiving data via a network. Accordingly, the network interface hardware 406 can include a communication transceiver for sending and/or receiving any wired or wireless communication. For example, the network interface hardware 406 may include an antenna, a modem, LAN port, Wi-Fi card, WiMax card, mobile communications hardware, near-field communication hardware, satellite communication hardware and/or any wired or wireless hardware for communicating with other networks and/or devices. The network interface hardware 406 of the drone management server 102 may transmit and/or receive data to or from the vehicle system 200 of the vehicle 106 and the drone 104 of FIG. 1.

The one or more memory modules 404 include a database 412, a user registration module 414, a drone registration module 416, a request reception module 418, a drone selection module 420, a contract creation module 422, a drone service management module 424, a media reception module 426, and a media transmission module 428. Each of the database 412, the user registration module 414, the drone registration module 416, the request reception module 418, the drone selection module 420, the contract creation module 422, the drone service management module 424, the media reception module 426, and the media transmission module 428 may be a program module in the form of operating systems, application program modules, and other program modules stored in the one or more memory modules 404. Such a program module may include, but is not limited to, routines, subroutines, programs, objects, components, data structures and the like for performing specific tasks or executing specific data types as will be described below.

The database 412 may store requests for drone-assisted media capture received by vehicles and media received from UAVs. The database 412 may also store other data received by and/or created by the drone management server 102 that may be used by the one or more memory modules 404 and/or other components of the drone management server 102, as discussed in further detail below.

The user registration module 414 may register a user account with the system 100. In some examples, a user may register an account with the system 100 through the vehicle system 200 of the vehicle 106. In other examples, a user may register an account through a website, smartphone app, or other platform. The registration information received by the user registration module 414 may be stored in the data storage component 214.

The user registration module 414 may receive personal information about a user such that the user can be identified by the drone management server 102. In some examples, the user registration module 414 may register payment information associated with the user (e.g., credit card information). The registered payment information may be utilized to automatically process payments for drone-assisted media capture service.

In some examples, the user registration module 414 may also register user requirements associated with a drone-assisted media capture service parameters specified by the user. The user requirements may comprise hard requirements and soft requirements associated with a user. The hard requirements may comprise service parameters that are required by the user. That is, the user will not accept drone-assisted media capture services that do not meet the hard requirements. The soft requirements may comprise service parameters that are preferred by the user but are not required by the user. Non-limiting examples of user requirements may include a minimum pixel size for photographs, a specific frame rate for video, a time horizon, lighting conditions, cost, data ownership, and the like.

When a user registers with the system 100, the user may specify hard and soft requirements. However, the user may change these requirements later by accessing their account. In some examples, the user may specify different requirements when requesting a specific drone-assisted media capture service from a vehicle. For example, when requesting drone-assisted media capture (e.g., through the vehicle system 200), a user may specify hard and/or soft requirements that may be different from the hard or soft requirements associated with the user. Any such requirements specified by a user in a particular request may override the requirements associated with the user's account.

The drone registration module 416 may register UAVs with the system 100. In particular, any owner or operator of a drone who wishes to allow their drone to be utilized for drone-assisted media capture may register the drone with the system 100. The drone registration module 416 may receive registration information associated with drones being registered.

In embodiments, when an owner or operator of a drone wishes to make their drone available to perform drone-assisted media capture, the owner/operator may register the drone with the drone management server 102. In particular, the owner/operator may register a drone by providing registration information associated with the drone to the drone management server 102. The registration information may be received by the drone registration module 416. The registration information associated with the drone may include specifications and performance capabilities of the drone. For example, the drone registration information may include a speed of the drone, a maximum altitude of the drone, as well as performance data associated with the drone's camera (e.g., pixel rate). This drone registration information may be received by the drone registration module 416 and stored in the database 412.

In some examples, the drone registration information may include contract information specified by the owner/operator of the drone. For example, the registration information may include a minimum price that the owner/operator is willing to accept for performance of different drone-assisted media capture services by the drone. This information may be used to create a contract for performance of drone-assisted media capture services, as discussed in further detail below. In some examples, the registration information may also include location information where the drone is typically housed. This may be used to determine proximity of drones to a location where drone-assisted media capture is desired.

The request reception module 418 may receive a request for drone-assisted media capture (e.g., from the vehicle system 200 of the vehicle 106). The request may indicate various parameters of drone-assisted media capture desired by the requesting user, as discussed above. The request may be associated with a registered user. If the request specifies one or more hard or soft requirements, those requirements may be associated with the request by the drone management server 102. However, if certain hard or soft requirements are not specified by the request, the request reception module 418 may access the registration information associated with the user submitting the request. If the user registration information for the user specifies any hard or soft requirements not included in the received requests, the hard or soft requirements of the user registration information may be associated with the request.

The drone selection module 420 may identify and select one or more drones that are able to provide the drone-assisted media capture specified in a request received by the request reception module 418. As discussed above, the drone registration module 416 may register drones that are able to provide drone-assisted media capture service and may store drone registration information associated with each registered drone. Thus, the drone selection module 420 may identify registered drones that have the capability to perform the requested drone-assisted media capture service.

The drone selection module 420 may first search for registered drones that are able to satisfy the hard requirements associated with the request received by the request reception module 418. If the drone selection module 420 is unable to identify any registered drones that are able to meet the hard requirements associated with the request, the drone selection module 420 may transmit a message to the requesting vehicle indicating that the request drone-assisted media capture service is unable to be provided at present time.

If the drone selection module 420 is able to identify multiple registered drones that are able to meet the hard requirements associated with the request, then the drone selection module 420 may identify and select the drone that meets the hard requirements and is able to best meet the soft requirements associated with the request. The identified drone may be utilized to perform the requested drone-assisted media capture service, as discussed below.

The contract creation module 422 may automatically establish a contract with the drone selected by the drone selection module 420. In some examples, after the drone selection module 420 identifies a drone to perform the requested drone-assisted media capture service, the contract creation module 422 may transmit a notification to the owner/operator of the drone and/or the requesting driver indicating that a contract has been established for the drone to provide the requested drone-assisted media capture service. In these examples, the requesting driver and the owner/operator of the drone agree to allow the drone management server 102 to automatically establish a contract when a drone roadside drone service for which the drone is suitable to provide is available. As such, the contract creation module 422 may automatically establish the contract with the requesting driver and the owner/operator of the drone for the drone to provide the requested drone-assisted media capture service.

In other examples, the contract creation module 422 may transmit a request to the requesting driver and/or the owner/operator of the selected drone to accept a contract for the drone to provide the requested drone-assisted media capture service. The requesting driver and/or the owner/operator may then either accept or reject the contract offer (e.g., through a website, smartphone app, or the vehicle system 200). If the contract offer is accepted by both parties, then the contract may be formed. If the offer is rejected by either party, then the drone management server 102 may attempt to find another drone to provide the service.

In embodiments, a contract formed by the contract creation module 422 may specify a drone-assisted media capture service to be performed by a drone and a price to be paid for the provision of the service. In some examples, the user registration information received by the user registration module 414 may specify a maximum price that a user is willing to pay and the drone registration information received by the drone registration module 416 may specify a minimum price that the owner/operator of a drone is willing to accept for different services. In these examples, the contract creation module 422 may match a user and a drone to provide the requested service at a price acceptable to both parties. In some examples, the contract creation module 422 may automatically facilitate payment between the user and the owner/operator of the selected drone.

Referring still to FIG. 4, the drone service management module 424 may cause the drone selected by the drone selection module 420 to perform the requested drone-assisted media capture. In particular, the drone service management module 424 may transmit a signal to the selected drone to cause the selected drone to travel to the location of the vehicle 106 associated with the request and capture the photographs, video, and/or audio specified in the request. The drone may arrive at the specified location even after the vehicle 106 has left the location. As discussed above, the request for drone-assisted media capture may specify various parameters, such as the height, angle, and orientation that requested media should be taken from. Accordingly, the drone service management module 424 may cause the drone to capture the photographs, video, and/or audio to meet the parameters specified in the request.

In some examples, the request may specify an orientation at which media should be captured with respect to the vehicle orientation (e.g., take photographs to the left of the vehicle). Accordingly, in these examples, the drone service management module 424 may identify the vantage point from which media should be captured based on the received request, the received vehicle location, as determined by the location detection module 304, and the received vehicle orientation, as determined by the orientation detection module 306. The drone service management module 424 may then transmit the determined vantage point to the selected drone such that the drone can capture the media from the appropriate vantage point.

In some examples, the request may specify a time of day or a particular date that the media should be captured. In these examples, the drone service management may cause the selected drone to arrive at the specified location at the specified time and/or. In other examples, the request may specify that media should be captured with a particular lighting condition (e.g., photographs should be taken before sunset). In these examples, the drone service management module 424 may determine when the appropriate lighting condition will occur (e.g., by accessing a weather or other database associated with the specified location) and cause the selected drone to arrive at the specified location at the appropriate time.

The media reception module 426 may receive media (e.g., photographs, video, and/or audio) captured by a drone performing drone-assisted media capture. As discussed above, the drone service management module 424 may cause a drone to travel to the location specified by a request for drone-assisted media capture and captured desired media. After the drone captures the desired media, the drone may transmit the captured media to the drone service management module 424. The captured media may be received by the media reception module 426 and may be stored in the database 412.

The media transmission module 428 may transmit the media received by the media reception module 426 to the requesting user. For example, the media transmission module 428 may e-mail the captured media to the user or allow the user to view the captured media in a web portal, smartphone app, or other application software. As such, the user can request drone-assisted media capture while they are driving, and then view the images or other captured media when they are no longer driving.

In some examples, the media transmission module 428 may transmit the media received by the media reception module 426 to the vehicle system 200 of the vehicle 106. In these examples, the captured media may be received by the vehicle system 200 and displayed on the display device 220. Thus, a driver or other occupants of the vehicle 106 may view the media as they are captured in real-time.

In some examples, as the user views the captured media, if the user decides that the images or other media are not satisfactory, the user may request that the images or other media be retaken. The user may specify modified parameters for retaking the media. For example, the user may specify that the media be retaken at a different time of day or from a different angle or vantage point. When the user requests the media to be retaken, the request may be transmitted to the drone management server 102 and received by the request reception module 418. The drone management server 102 may then process the new request in a similar manner as discussed above for processing the initial request received from the vehicle service and may cause a drone to travel back to the specified location and retake the images or other media based on the revised parameters. In some examples, the drone management server 102 may cause the same drone that captured the original media to retake the media. In other examples, the drone management server 102 may cause a different drone to retake the media.

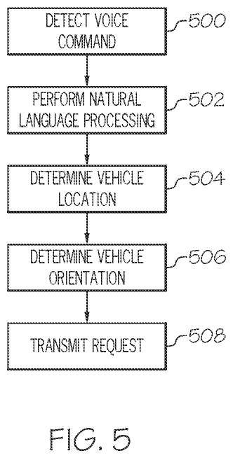

FIG. 5 depicts a flowchart of an example method that may be performed by the vehicle system 200 of the vehicle 106 to transmit a request for drone-assisted media capture to the drone management server 102. At step 500, the voice detection module 300 detects a voice command spoken by the driver or other occupant of the vehicle 106. The voice detection module 300 may detect the voice command by the audio input device 216. The detected voice command may be stored in the data storage component 214.

At step 502, the natural language processing module 302 performs natural language processing on the voice command detected by the voice detection module 300. In particular, the natural language processing module 302 may perform natural language processing to analyze the contents of the voice command and identify a request for drone-assisted media capture based on the voice command. The natural language processing module 302 may determine parameters of the request for drone-assisted media capture such as when media should be captured, where media should be captured, at what vantage point or angle media should be captured, and the like.

At step 504, the location detection module 304 may detect the location of the vehicle 106. At step 506, the orientation detection module 306 may detect the orientation of the vehicle 106. At step 508, the request transmission module 308 may transmit, to the drone management server 102, the request for drone-assisted media capture determined by the natural language processing module 302 along with the vehicle location determined by the location detection module 304 and the orientation detection module 306.

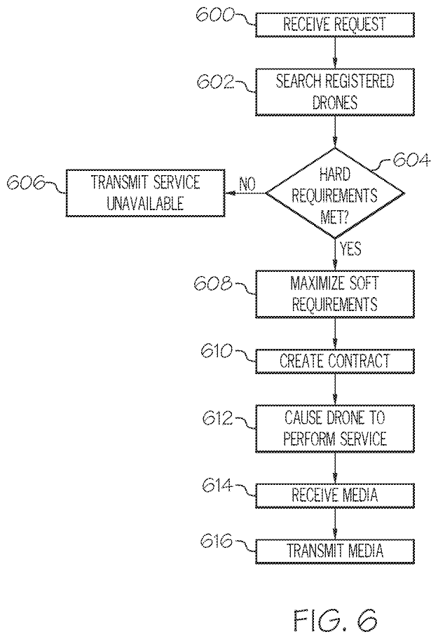

FIG. 6 depicts a flowchart of an example method that may be performed by the drone management server 102 to provide drone-assisted media capture. At step 600, the request reception module 418 receives a request for drone-assisted media capture from the vehicle 106. The request may specify parameters associated with photographs, video and/or audio to be captured as discussed above. In particular, the request may include hard requirements and soft requirements.

At step 602, the drone selection module 420 searches for drones that have been registered with the drone registration module 416 that are able to perform the requested service received by the request reception module 418. At step 604, the drone selection module 420 determines whether any registered drones have been found that are able to meet the hard requirements associated with the received request. If the drone selection module 420 is unable to find any registered drones that are able to meet the hard requirements (No at step 604), then at step 606, the drone selection module 420 transmits a message to the requesting vehicle indicating that the requested drone-assisted media capture is unable to be performed at the present time. If the drone selection module 420 is able to find one or more registered drones that are able meet the hard requirements (Yes at step 604), then control passes to step 608.

At step 608, the drone selection module 420 selects, from among all the drones that are able to meet the hard requirements, the drone that is best able to meet the soft requirements associated with the received request. At step 610, the contract creation module 422 creates a contract between the user that transmitted the request for drone-assisted media capture and the owner or operator of the drone selected by the drone selection module 420.

At step 612, the drone service management module 424 causes the drone selected by the drone selection module 420 to travel to the location associated with the received request and capture the photographs, video, and/or audio specified in the request. At step 614, the media reception module 426 receives the captured media from the selected drone. At step 616, the media transmission module 428 transmits the received media to the user that requested the drone-assisted media capture.

It should now be understood that embodiments described herein are directed to methods and systems for performing drone-assisted media capture. While a driver is driving a vehicle along a road, the driver may see a scene that they wish to capture in a photograph or other media. The driver may use voice commands to request a drone to travel to the vehicle location and captured the photograph or other media. The driver may specify various parameters of the media to be captured in the voice command.

A vehicle system of the vehicle may detect the voice command and perform natural language processing to determine the content of the request including the specified parameters. The vehicle system may transmit the request for drone-assisted media capture to a drone management server.

The drone management server may receive the request and select a registered drone that is able to perform the requested drone-assisted media capture. The drone management server may establish a contract between the driver and an owner/operator of the drone to perform the request. The drone may travel to the location that the vehicle was located when the request was made and capture the media specified by the user. The drone may transmit the captured media to the drone management server. The drone management server may receive the captured media from the drone and may transmit the media to the user so that the user may view the media.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving a request for drone-assisted media capture from a vehicle located at a first location, the request specifying one or more user preferences;
selecting an unmanned aerial vehicle that is able to perform the drone-assisted media capture based on the user preferences;
causing the selected unmanned aerial vehicle to travel to the first location; and
causing the selected unmanned aerial vehicle to capture media at the first location based on the user preferences.

2. The method of claim 1, further comprising:
receiving the captured media from the selected unmanned aerial vehicles; and
transmitting the captured media to a driver of the vehicle.

3. The method of claim 1, further comprising:
receiving a requested time of day for the drone-assisted media capture; and
causing the selected unmanned aerial vehicle to arrive at the first location at the requested time of day.

4. The method of claim 1, further comprising:
receiving a requested date for the drone-assisted media capture; and
causing the selected unmanned aerial vehicle to arrive at the first location at the requested date.

5. The method of claim 1, further comprising;
receiving a requested orientation for the drone-assisted media capture; and
causing the selected unmanned aerial vehicle to capture the media with the requested orientation.

6. The method of claim 1, further comprising:
creating a contract for the selected unmanned aerial vehicle to perform the drone-assisted media capture.

7. The method of claim 1, further comprising:
receiving user registration information for a user associated with the vehicle, the user registration information including hard requirements and soft requirements;
receiving drone registration information associated with one or more registered unmanned aerial vehicles, the drone registration information indicating performance capabilities of each of the one or more registered unmanned aerial vehicles;
identifying one or more of the registered unmanned aerial vehicles that are able to satisfy the hard requirements based on the drone registration information; and
selecting the unmanned aerial vehicle from among the identified one or more of the registered unmanned aerial vehicles.

8. The method of claim 7, further comprising:
selecting the unmanned aerial vehicle from among the identified one or more of the registered unmanned aerial vehicles that is able to best satisfy the soft requirements.

9. The method of claim 1, further comprising:
receiving a modified request for drone-assisted media capture, the modified request specifying one or more modified user preferences;
selecting a second unmanned aerial vehicle that is able to perform the drone-assisted media capture based on the modified user preferences;
causing the second unmanned aerial vehicle to travel to the first location; and
causing the second unmanned aerial vehicle to capture a second set of media at the first location based on the modified user preferences.

10. A remote computing device comprising:
a processor configured to:
receive a request for drone-assisted media capture from a vehicle located at a first location, the request specifying one or more user preferences;
select an unmanned aerial vehicle that is able to perform the drone-assisted media capture based on the user preferences;
cause the selected unmanned aerial vehicle to travel to the first location; and
cause the selected unmanned aerial vehicle to capture media at the first location based on the user preferences.

11. The remote computing device of claim 10, wherein the processor is further configured to:
receive the captured media from the selected unmanned aerial vehicles; and
transmit the captured media to a driver of the vehicle.

12. The remote computing device of claim 10, wherein the processor is further configured to:
receive a requested time of day for the drone-assisted media capture; and
cause the selected unmanned aerial vehicle to arrive at the first location at the requested time of day.

13. The remote computing device of claim 10, wherein the processor is further configured to:
receive a requested date for the drone-assisted media capture; and
cause the selected unmanned aerial vehicle to arrive at the first location at the requested date.

14. The remote computing device of claim 10, wherein the processor is further configured to;
receive a requested orientation for the drone-assisted media capture; and
cause the selected unmanned aerial vehicle to capture the media with the requested orientation.

15. The remote computing device of claim 10, wherein the processor is further configured to:
create a contract for the selected unmanned aerial vehicle to perform the drone-assisted media capture.

16. The remote computing device of claim 10, wherein the processor is further configured to:
receive user registration information for a user associated with the vehicle, the user registration information including hard requirements and soft requirements;
receive drone registration information associated with one or more registered unmanned aerial vehicles, the drone registration information indicating performance capabilities of each of the one or more registered unmanned aerial vehicles;
identify one or more of the registered unmanned aerial vehicles that are able to satisfy the hard requirements based on the drone registration information; and
select the unmanned aerial vehicle from among the identified one or more of the registered unmanned aerial vehicles.

17. The remote computing device of claim 16, wherein the processor is further configured to:
select the unmanned aerial vehicle from among the identified one or more of the registered unmanned aerial vehicles that is able to best satisfy the soft requirements.

18. The remote computing device of claim 10, wherein the processor is further configured to:
receive a modified request for drone-assisted media capture, the modified request specifying one or more modified user preferences;
select a second unmanned aerial vehicle that is able to perform the drone-assisted media capture based on the modified user preferences;
cause the second unmanned aerial vehicle to travel to the first location; and
cause the second unmanned aerial vehicle to capture a second set of media at the first location based on the modified user preferences.

19. A system comprising:
a plurality of unmanned aerial vehicles; and
a remote computing device storing drone registration information indicating performance capabilities of each of the unmanned aerial vehicles;
wherein the remote computing device comprises a processor configured to:
receive a request for drone-assisted media capture from a vehicle located at a first location, the request specifying one or more user preferences;
select an unmanned aerial vehicle from among the plurality of unmanned aerial vehicles that is able to perform the drone-assisted media capture based on the user preferences and the drone registration information;
cause the selected unmanned aerial vehicle to travel to the first location; and
cause the selected unmanned aerial vehicle to capture media at the first location based on the user preferences.

20. The system of claim 19, wherein the processor is further configured to:
receive the captured media from the selected unmanned aerial vehicles; and
transmit the captured media to a driver of the vehicle.
